(19) United States
(12) Patent Application Publication
(10) Pub. No.: US 2002/0089839 A1
(43) Pub. Date: Jul. 11, 2002

(54) Method for designing the light conductor with two side light sources and the structure thereof

(76) Inventors: Hui-Liang Chien, Taichung (TW); Che-Chin Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/867,482

(22) Filed: May 31, 2001

(30) Foreign Application Priority Data
Jan. 9, 2001 (TW) 090100579

(51) Int. Cl. F21V 8/00

(52) U.S. Cl. 362/31; 362/243; 349/65; 362/561

(57) ABSTRACT

A method for designing the light conductor and the structure by utilizing two side light sources comprises a light conductor, a light source arranged on tow sides of the light conductor. The back of the light conductor provides a reflecting board. The back of the light conductor forms a pattern with a special area distribution ratio function to solve the weak luminance problem the LCD often encounters. It saves the electrical energy and permits more ray of light delivered from the light conductor to enhance the luminance and uniformity of the light conductor.

### BACKGROUND OF THE INVENTION

1. Field of the Invention

The invention relates to a method for designing the light conductor with two side light sources and the structure thereof. It is intended to provide a solution to the nasty problem of the corner weak luminance, which occurs more than often in the light conductor in the liquid crystal display. In the mean time, it is a design for saving electrical energy and enhancing the luminance and uniformity of the light conductor structure.

2. Description of the Prior Art

The prior art of the LCD light conductor is shown in the FIG. 1 which comprising a plurality of light sources 1. The light sources are arranged around the periphery of the light conductor 4. The back of light conductor 4 is provided with patterns. When the light conductor 4 is started, the light courses 1 will emanates the ray of light 3 which advances along and emits out of the light conductor 4.

The aforesaid pattern distribution area of the light conductor 4 is as usual affected by the concept of the designer who often thinks that the distribution density of the net point is higher at the far light source than the near light source. It is therefore thought the light density is concentrated along the centerline of the light conductor 4, then gradually diminished in proportion on the periphery of the light conductor 4. As a matter of fact, the light sources are so arranged that the light intensity is the strongest in the center, when close to the rim, the light intensity is near to zero. The phenomena produces a weak luminance at the diagonal comers 2 of the light conductor 4, greatly decreasing the efficiency of the back light devise and increasing the power consumption of the light source 1.

It is seemed that the prior art is not good design, leaving significant room for improvement.

### SUMMARY OF THE INVENTION

The purpose of the invention is to provide a method for designing a light conductor by utilizing two side light sources and the structure thereof. The adoption of two side light sources embraces an attempt to reduce to the minimum the power consumption, and takes account of the light source at the left side of the light conductor to compensate the weak luminance at the right comer, or vice versa so as to solve the problem of the corner weak luminance.

Another purpose of the invention is to provide a method for designing the light conductor with two side light sources which emit out from the frontage to strengthen the luminance and uniformity of the light conductor.

To achieve the aforementioned purpose the invention inheres, the two side light sources are utilized to the greatest advantage in a method to design the light conductor in which the light sources are arranged at two sides of the light conductor with a reflecting board outfitted on the back. The back of the light conductor is integrally formed by laser processing or plastic intrusion having a pattern designed with a special area distribution ratio function. The pattern design take into account the left light source of the light conductor will be employed to compensate the weak luminance at the right corner, or vice versa, so as to solve the weak luminance in both left and right comers and to save much of the electrical consumption. In addition, the invention provides a preferable embodiment where the light conductor is processed with gradual sand blasting and etching to attain the finest net points. When the light as is advancing in the light conductor will be shattered by the net points to obtain the entire reflection, emitting out form the frontage of light conductor with brighter luminance and uniformity.

### BRIEF DESCRIPTION OF THE DRAWINGS

The drawings disclose an illustrative embodiment of the present invention which serves to exemplify the various advantages and objects hereof, and are as follows:

FIG. 1 is the light tracking diagram of the prior art of light guide.

FIG. 2 is the light tracking diagram of the light conductor employing two side light sources provided in the invention FIG. 3 is the function diagram with changing density on the back pattern of the light conductor employing two side light sources provided in the invention.

FIG. 4 is the schematic diagram of back pattern design of the light conductor employing two side light sources.

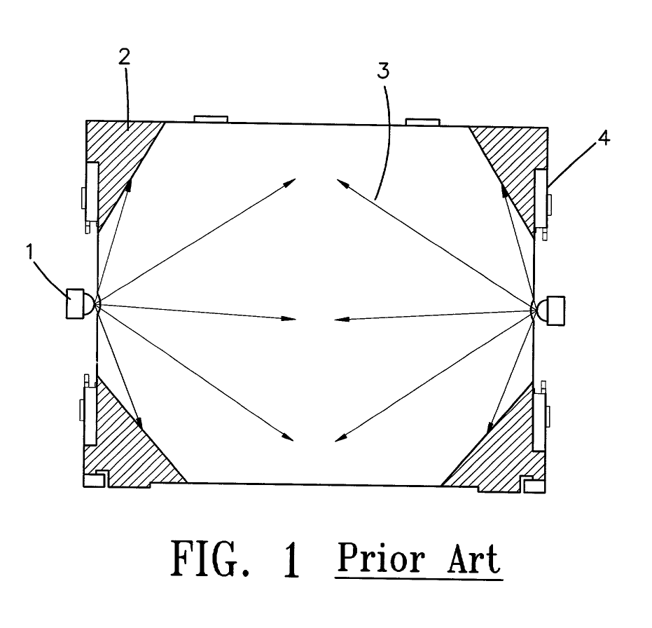

### DETAILED DESCRIPTION OF THE PREFERRED EMBODIMENT

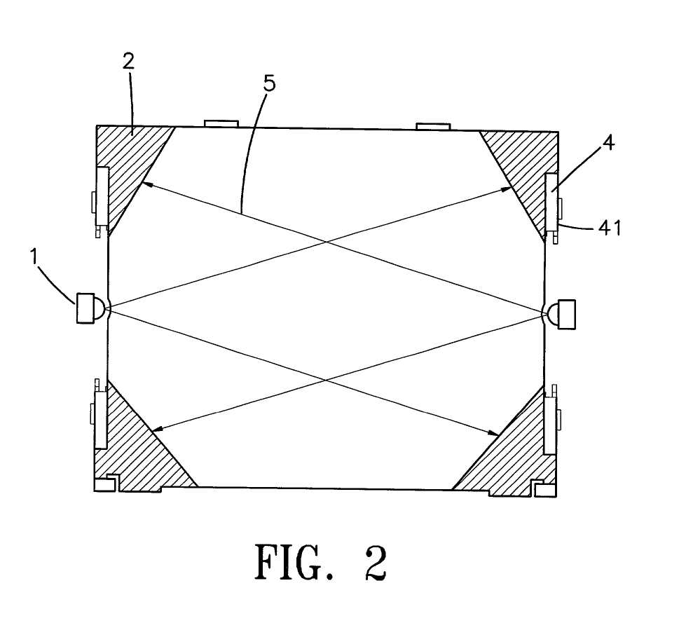

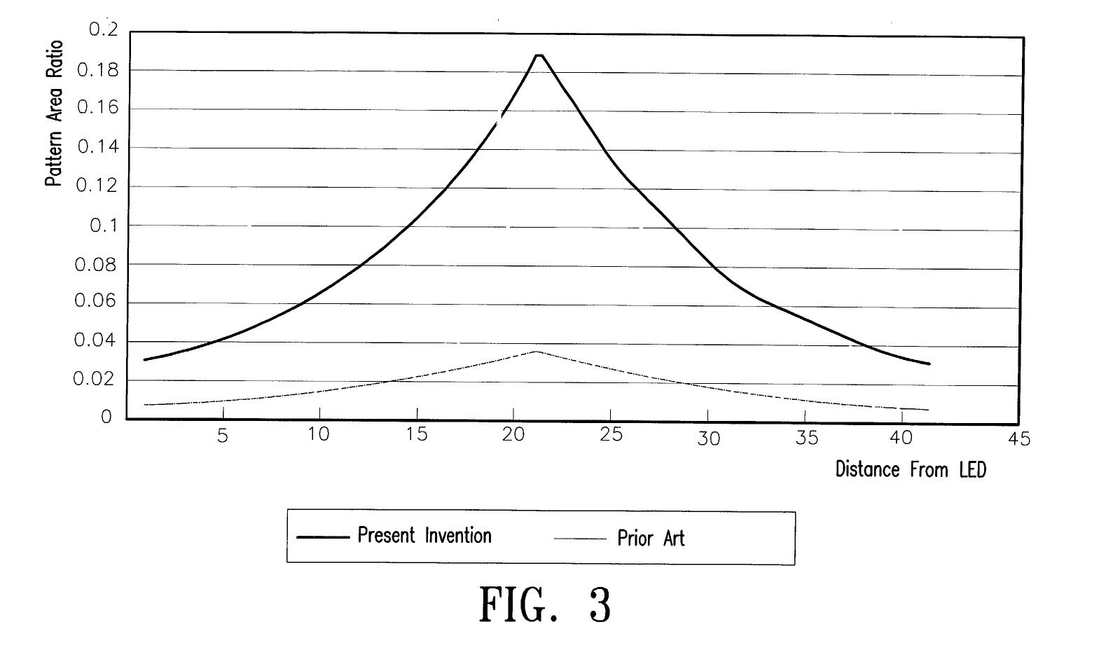

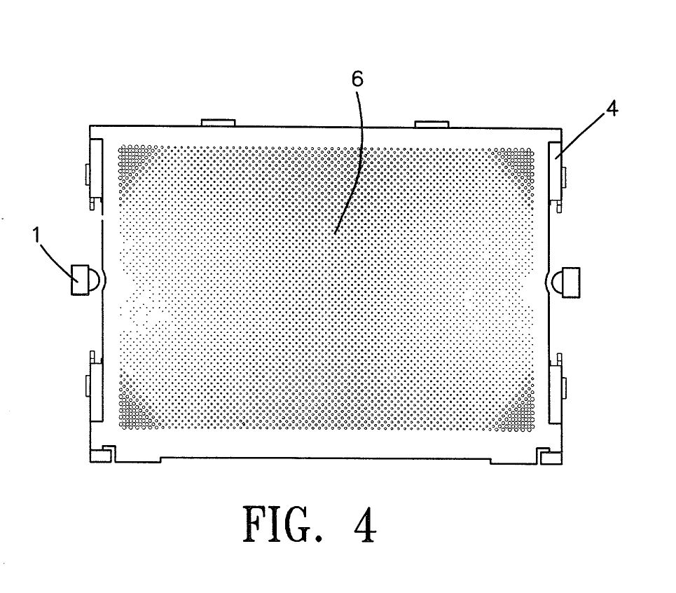

Please refer to FIGS. 2 and 4, both show the light conductor employing two side light sources according to the invention. Two light sources 1 are arranged on two sides of the light conductor 4 at the side centers or corners. The back of the light conductor 4 is outfitted a reflecting board. The back of light conductors forms a pattern 6 having a special area distribution ratio function. In the pattern 6, the area distribution of the net point is flocked on the diagonal corners 2 of the light conductor 4. The special area distribution ratio function on the pattern 6 are formed by means of laser processing, plastic extrusion, printing, pressing, mechanical processing, exposure processing or other known method. When the light conductor 4 is put on work, the ray light form the light source will emit more ray of light than the prior art and produces an entire reflection of light to dark region of the diagonal corners.

As shown in FIG. 3, the invention is designed to compensate the weak luminance at right comer with the left light source, or vice versa. In which the net point area distribution ratio on the pattern 6 is less in number than that of the design of the prior art, which permits more ray of light 5 continuing to reflect to the dark region of two diagonal corners.

Please refer to FIG. 4, which show the proper method to design the light conductor 4. The back of the light conductor forms a pattern with a special area distribution ratio function. Add a reflecting board 41 to the back of the light conductor 4. The light sources are arranged on Two sides of the light conductor. This is a complete light conductor 4 concept employing two side light sources. The design of the pattern 6 lays on the adjustment of area distribution ratio. When the board is 1 mm in thickness, the back pattern shall be designed in accordance with the following equations.

A1(x)=a1(y)*e^{b1(y)*x} (1)

A2(x)=a2(y)*e^{b2(y)*x} (2)

Where An(x) represents the ratio of the net point area distribution against the view window area (n=1 or 2), x represent the distance between the light source and the point area distribution; A1(x) equals to the area divided by the product of L and P_{L}. (the area in the intermediate region.) A2(x) uses the similar computation.

L represents the maximum distance between the light source and the point distribution in the pattern 6. an(y) and bn(y) is the co-efficient in relation with L. In which

b(L)=D(L)*e^{-0.0179*L} (3)

b1(y)=b(L)*e^{(-0.02*y)} (4)

b2(y)=b(L)*e^{(-0.06*y)} (5)

[dA(x)/dx]*L=0.5˜0.7 (6)

an(y)=A1(L)/e^{(bn(y)*L)} (7)

An(L)=A(L)*b(L)/bn(y) (8)

The aforementioned equations are derivatives from the laser processing simulations and the experimental parameters of the physical extrusion of the light conductor structure. They are applicable to the design of the light conductor by means of laser processing or plastic extruding. Where D(L) is the depth and L related functions of the point on the pattern 6. Taking 1 mm thick board as an example, supposing the mean point depth is 20-30 μm, the equivalent value is about 0.1. Because the area distribution ratios is the domain parameter in the pattern 6, the point design is irrespective of its shapes and pitch of the point, so the area distribution ratio is allowed to attain the maximum. A(L) is a co-efficient controlling point area distribution ration at the far end of view window with an effort to gain the highest point area distribution ratio without cross overlapping and to enhance to the maximum the net point area distribution ratio; if the point light source is comparatively scattered, then the value derived from the equation (6) shall be 0.5˜0.7. When the net points among the point light source are intensified, the light source is distributed more evenly.

The above equation is suitable for 1 mm board. If the thickness of the board varies, the point depth can be employed to control the uniformity, or D(L) is applied as an adjustment factor.

The invention provides a method for designing the light conductor by employing two side light source and the structure thereof. The side light sources are used to the greater advantage to minimize the power consumption, and to compensate the weak luminance at the right comer with the left light source, or vice versa which is the resolve to improve the weak luminance often occurred in the prior art. In the meantime, the fine etched net points formed by the gradual dense sand blasting process will reinforce the luminance and uniformity of the light conductor structure.

Many changes and modifications in the above described embodiment of the invention can, of course, be carried out without departing from the scope thereof. Accordingly, to promote the progress in science and the useful arts, the invention is disclosed and intended to be limited only by the scope of the appended claims.

What is claimed is:

1. A method for designing the light conductor by utilizing two side light source, comprising the following steps:
a) forming the light conductor having a pattern on the back with a special area distribution ratio functionh;
b) installing a reflecting board on the back of the light conductor, and
c) erecting at least a light source respectively on a left and a right side of the light conductor.

2. A method for designing the light conductor by utilizing two side light source as recited in claim 1, in which the back pattern is designed to take account of the left light source to compensate the weak luminance at the right corner, or vice versa in compliance with the following equations:
A1(x)=a1(y)*e^{b1(y)*x} (1)
A2(x)=a2(y)*e^{b2(y)*x} (2)
where An(x) represents the ratio of the net point area distribution against the view window area (n=1 or 2), x represent the distance between the light source and the point area distribution;
L represents the maximum distance between the light source and the point distribution in the pattern 6; an(y) and bn(y) is the co-efficient in relation with L; in which
b(L)=D(L)*e^{-0.0179*L} (3)
b1(y)=b(L)*e^{(-0.02*y)} (4)
b2(y)=b(L)*e^{(-0.06*y)} (5)
[dA(x)/dx]*L=0.5˜0.7 (6)
an(y)=A1(L)/e^{(bn(y)*L)} (7)
An(L)=A(L)*b(L)/bn(y) (8)
where D(L) is the depth and L related functions of the point on the pattern 6; the board is generally 1 mm thick and the mean point depth is 20-30 μm, the equivalent value is about 0.1; in design stage, draw a picture showing an incoming light on a single side, and the L is set to be the distance from the near light to the view window area; then cut off the far end light corner with dense pattern and overlap it on the near light corner to produce a even distribution.

3. A method for designing the light conductor by utilizing two side light source as recited in claim 1, the pattern is produced by means of laser processing, plastic injecting, printing, extruding, mechanical processing or exposure processing.

4. A method for designing the light conductor by utilizing two side light source as recited in claim 1, in which the pattern is formed with the finest net points by means of gradual sand blast processing.

5. A light conductor employing two side light sources, compriseing:
a light conductor having a back which provides a pattern with a special area distribution ratio function; a net point area of the pattern has a densest distribution area at the diagonal corner of the light conductor;
a light sources arranged on the left and right sides of the light conductor; and
a reflecting board mounted on the back of the back of the light conductor.

6. A light conductor employing two side light sources as recited in claim 5, in which the light sources are arranged at the center of both sides of the light conductor.

7. A light conductor employing two side light sources as recited in claim 5, in which the light sources can be arranged at any place along both sides of the light conductor.
